(19) United States
(12) Patent Application Publication
(10) Pub. No.: US 2022/0009201 A1
(43) Pub. Date: Jan. 13, 2022

(54) COLD-FORMED GLASS ARTICLE HAVING DUAL ADHESIVE SYSTEM AND PROCESS FOR COLD-FORMING GLASS ARTICLES

(71) Applicant: CORNING INCORPORATED, CORNING, NY (US)

(72) Inventors: Atul Kumar, Horseheads, NY (US); Arlin Lee Weikel, Mansfield, PA (US)

(21) Appl. No.: 17/294,882

(22) PCT Filed: Oct. 29, 2019
(86) PCT No.: PCT/US2019/058539

§ 371 Date: May 18, 2021

Related U.S. Application Data
(60) Provisional application No. 62/769,926, filed on Nov. 20, 2018.

(51) Int. Cl. B32B 7/12; B32B 17/06; C03B 23/023; C09J 5/06; C09J 7/38

(52) U.S. Cl. CPC B32B 7/12; B32B 17/06; C03B 23/023; C09J 5/06; C09J 2400/143; B32B 2307/732; B32B 2457/20; B32B 2605/00; C09J 7/38

(57) ABSTRACT

Disclosed herein are embodiments of a method of forming a curved glass article. In the method, a first adhesive is applied to a first region of a frame or of a glass cover sheet. The frame includes a curved surface. A second adhesive is applied to a second region of the frame or of the glass cover sheet. The glass cover sheet is molded to the frame so as to conform the glass cover sheet to the curved surface of the frame. The first adhesive is cured at a first temperature for a first time period, and the second adhesive is cured at a second temperature for a second period of time. The second temperature is lower than the first temperature, and the second period of time is longer than the first period of time. Also disclosed herein are embodiments of a curved glass article.

### CROSS-REFERENCE TO RELATED APPLICATIONS

This application claims the benefit of priority under 35 U.S.C. § 119 of U.S. Provisional Application Ser. No. 62/769,926 filed on Nov. 20, 2018 the content of which is relied upon and incorporated herein by reference in its entirety.

### BACKGROUND

The disclosure relates to vehicle interior systems including glass and methods for forming the same, and more particularly to vehicle interior systems including a curved glass article with a cold-formed or cold-bent cover glass and methods for forming the same.

Vehicle interiors include curved surfaces and can incorporate displays in such curved surfaces. The materials used to form such curved surfaces are typically limited to polymers, which do not exhibit the durability and optical performance as glass. As such, curved glass substrates are desirable, especially when used as covers for displays. Existing methods of forming such curved glass substrates, such as thermal forming, have drawbacks including high cost, optical distortion, and surface marking. Accordingly, Applicant has identified a need for vehicle interior systems that can incorporate a curved glass substrate in a cost-effective manner and without problems typically associated with glass thermal forming processes.

### SUMMARY

According to an aspect, embodiments of the disclosure relate to a method of forming a curved glass article. In the method, a first adhesive is applied to a first region of a frame or of a glass cover sheet. The frame includes a curved surface. A second adhesive is applied to a second region of the frame or of the glass cover sheet. The glass cover sheet is molded to the frame so as to conform the glass cover sheet to the curved surface of the frame. The first adhesive is cured at a first temperature for a first time period, and the second adhesive is cured at a second temperature for a second period of time. The second temperature is lower than the first temperature, and the second period of time is longer than the first period of time.

According to another aspect, embodiments of the disclosure relate to a glass article. The glass article includes a glass cover sheet having a first major surface and a second major surface. The second major surface includes a first curve. The glass article also includes a frame having a third major surface and a fourth major surface. The third major surface includes a second curve. The second major surface of the cover glass sheet faces the third major surface of the frame, and the second curve complements the first curve. A first adhesive is disposed in a first region between the first major surface of the frame and the second major surface of the glass cover sheet. A second adhesive is disposed in a second region between the first major surface of the frame and the second major surface of the glass cover sheet. The first adhesive is configured to cure to a first cured strength after a first cure time at first cure temperature, and the second adhesive is configured to cure to a second cured strength after a second cure time longer than the first cure time at a second cure temperature lower than the first cure temperature. The second cured strength is greater than the first cured strength.

According to still another aspect, embodiments of the disclosure relate to a method of forming a curved glass article. In the method, a pressure sensitive structural adhesive is applied to at least a portion of a frame or of a glass cover sheet. The frame has a curved surface. A glass cover sheet is molded to the frame so as to conform the glass cover sheet to the curved surface of the frame. Pressure is applied to the pressure sensitive structural adhesive at a first temperature for a first time period. The pressure sensitive structural adhesive is cured at a second temperature for a second period of time. The second temperature is lower than the first temperature, and the second period of time is longer than the first period of time.

According to yet another aspect, embodiments of the disclosure relate to a glass article. The glass article includes a glass cover sheet having a first major surface and a second major surface in which the second major surface includes a first curve. The glass article also includes a frame having a third major surface and a fourth major surface. The third major surface includes a second curve. The second major surface of the cover glass sheet faces the third major surface of the frame, and the second curve complements the first curve. A pressure sensitive structural adhesive is disposed between the first major surface of the frame and the second major surface of the glass cover sheet. The pressure sensitive structural adhesive is configured to cure to a first cured strength after a first cure time at first cure temperature and to cure to a second cured strength after a second cure time longer than the first cure time at a second cure temperature lower than the first cure temperature. The second cured strength is greater than the first cured strength.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a vehicle interior with vehicle interior systems, according to exemplary embodiments.

FIG. 2 is a cross-sectional view of a glass substrate following cold bending and attachment to a curved frame, according to an exemplary embodiment.

FIGS. 3A-3C depict various adhesive layer configurations for glass laminate articles, according to an exemplary embodiment.

FIG. 4 depicts a mechanical interlock between a second adhesive of the adhesive layer and the frame, according to an exemplary embodiment.

FIG. 5 is a front perspective view of a glass substrate, according to an exemplary embodiment.

FIG. 6 is a perspective view of a curved glass substrate with multiple convex and concave curved surfaces, according to an exemplary embodiment.

### DETAILED DESCRIPTION

Reference will now be made in detail to various embodiments, examples of which are illustrated in the accompanying drawings. In general, a vehicle interior system may include a variety of different curved surfaces that are designed to be transparent, such as curved display surfaces and curved non-display glass covers, and the present disclosure provides articles and methods for forming these curved surfaces from a glass material. Forming curved vehicle surfaces from a glass material provide a number of advantages compared to the typical curved plastic panels that are conventionally found in vehicle interiors. For example, glass is typically considered to provide enhanced functionality and user experience in many curved cover material applications, such as display applications and touch screen applications, compared to plastic cover materials.

Accordingly, as will be discussed in more detail below, Applicant has developed a glass article and related manufacturing processes that provide an efficient and cost effective way to form an article, such as a display for a vehicle interior system, utilizing a cold-bent piece of glass substrate.

In particular embodiments, the glass substrate is bent to the curved shape within a mold (e.g., supported by a curved mold surface) via application of a force (e.g., via a vacuum chuck, electrostatic chuck, vacuum bag, a press, etc.). As disclosed herein, the curved shape is maintained initially using a first adhesive at an elevated temperature and for a relatively short time period to provide initial green strength (i.e., a level of strength that allows for processing and handling that is lower than the final bonding strength) to hold the curved shape of the glass substrate. Thereafter, the glass article is removed from the mold and a second adhesive is allowed to cure for an extended period of time at ambient temperature to provide a full structural bond between the glass substrate and frame. However, in embodiments, a single adhesive can be used if the adhesive has a first early cure strength and a late structural cure strength. A glass article formed using such a dual adhesive system as disclosed herein allows for a more economical manufacturing process. In particular, the glass article is able to spend less time at an elevated temperature and under vacuum, which provides cost savings.

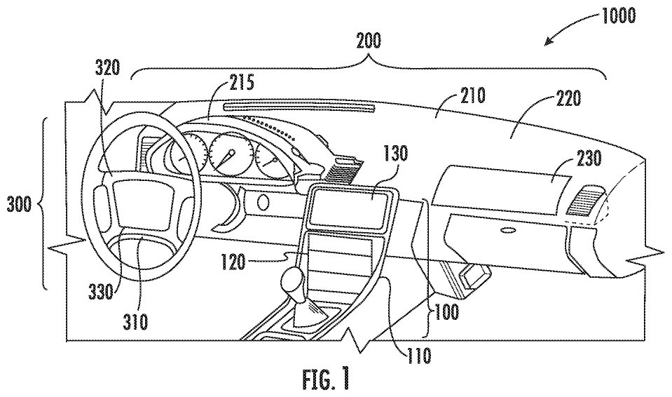

FIG. 1 shows an exemplary vehicle interior 1000 that includes three different embodiments of a vehicle interior system 100, 200, 300. Vehicle interior system 100 includes a frame, shown as center console base 110, with a curved surface 120 including a curved display 130. Vehicle interior system 200 includes a frame, shown as dashboard base 210, with a curved surface 220 including a curved display 230. The dashboard base 210 typically includes an instrument panel 215 which may also include a curved display. Vehicle interior system 300 includes a frame, shown as steering wheel base 310, with a curved surface 320 and a curved display 330. In one or more embodiments, the vehicle interior system includes a frame that is an arm rest, a pillar, a seat back, a floor board, a headrest, a door panel, or any portion of the interior of a vehicle that includes a curved surface. In other embodiments, the frame is a portion of a housing for a free-standing display (i.e., a display that is not permanently connected to a portion of the vehicle).

The embodiments of the curved glass article described herein can be used in each of vehicle interior systems 100, 200 and 300. Further, the curved glass articles discussed herein may be used as curved cover glasses for any of the curved display embodiments discussed herein, including for use in vehicle interior systems 100, 200 and/or 300. Further, in various embodiments, various non-display components of vehicle interior systems 100, 200 and 300 may be formed from the glass articles discussed herein. In some such embodiments, the glass articles discussed herein may be used as the non-display cover surface for the dashboard, center console, door panel, etc. In such embodiments, glass material may be selected based on its weight, aesthetic appearance, etc. and may be provided with a coating (e.g., an ink or pigment coating) with a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront functionality.

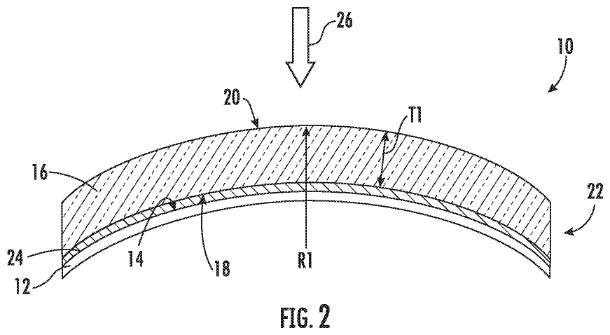

FIG. 2 depicts a curved glass article 10, such as the cover glass for curved display 130, according to exemplary embodiments. It should be understood that while FIG. 2 is described in terms of forming curved display 130, the curved glass article 10 of FIG. 2 may be used in any suitable curved glass application, including any curved glass component of any of the vehicle interior systems of FIG. 1. Such curved glass components could be display or non-display regions, e.g., a flat display area and a curved non-display area, curved displays, and curved display and curved non-display areas.

In FIG. 2, a frame 12 includes a curved surface, shown as curved surface 14. Curved glass article 10 includes a glass substrate 16. Glass substrate 16 includes a first major surface 18 and a second major surface 20 opposite first major surface 18. A minor surface 22 connects the first major surface 18 and the second major surface 20, and in specific embodiments, minor surface 22 defines the outer perimeter of glass substrate 16. The glass substrate 16 is attached to the frame 12 via an adhesive layer 24. In embodiments, the adhesive layer 24 comprises at least two adhesives. In such embodiments, a first adhesive cures quickly at an elevated temperature to provide green strength, and a second adhesive cures over time at ambient temperature to provide long-term strength. In another embodiment, the adhesive layer 24 is a single adhesive that has a first cure strength at an elevated temperature and a second cure strength after sitting for an extended period of time at ambient temperature. In embodiments, the first cure strength or green strength is no more than 5 MPa, and the second cure strength or structural bond strength is more than 5 MPa.

In general, glass substrate 16 is cold formed or cold bent to the desired curved shape via application of a bending force 26. As shown in FIG. 2, following cold bending, the glass substrate 16 has a curved shape such that first major surface 18 and second major surface 20 each include at least one curved section having a radius of curvature. In the specific embodiments shown, curved surface 14 of frame 12 is a convex curved surface. In such embodiments, the glass substrate 16 is bent such that first major surface 18 defines a concave shape that generally conforms to the convex curved shape of curved surface 14, and second major surface 20 defines a convex shape that generally matches or mirrors the convex curved shape of curved surface 14. In such embodiments, surfaces 18, 20 both define a first radius of curvature R1 that generally matches the radius of curvature of curved surface 14 of frame 12. In particular embodiments, the early, high temperature cure strength of the adhesive layer 24 holds glass substrate 16 in the curved shape following removal of bending force 26.

In embodiments, R1 is between 30 mm and 5 m. Further, in embodiments, the glass substrate 16 has a thickness T1 (e.g., an average thickness measured between surfaces 18, 20) shown in FIG. 2 that is in a range from 0.05 mm to 2 mm. In specific embodiments, T1 is less than or equal to 1.5 mm and in more specific embodiments, T1 is 0.4 mm to 1.3 mm. Applicant has found that such thin glass substrates can be cold formed to a variety of curved shapes (including the relatively high curvature radii of curvature discussed herein) utilizing cold forming without breakage while at the same time providing for a high quality cover layer for a variety of vehicle interior applications. In addition, such thin glass substrates 16 may deform more readily, which could potentially compensate for shape mismatches and gaps that may exist relative to curved surface 14 and/or frame 12.

In various embodiments, first major surface 18 and/or the second major surface 20 of glass substrate 16 includes one or more surface treatments or layers. The surface treatment may cover at least a portion of the first major surface 18 and/or second major surface 20. Exemplary surface treatments include anti-glare surfaces/coatings, anti-reflective surfaces/coatings, and an easy-to-clean surface coating/treatment. In one or more embodiments, at least a portion of the first major surface 18 and/or the second major surface 20 may include any one, any two or all three of an anti-glare surface, an anti-reflective surface, and easy-to-clean coating/treatment. For example, first major surface 18 may include an anti-glare surface and second major surface 20 may include an anti-reflective surface. In another example, first major surface 18 includes an anti-reflective surface and second major surface 20 includes an anti-glare surface. In yet another example, the first major surface 18 comprises either one of or both the anti-glare surface and the anti-reflective surface, and the second major surface 20 includes the easy-to-clean coating.

In embodiments, the glass substrate 16 may also include a pigment design on the first major surface 18 and/or second major surface 20. The pigment design may include any aesthetic design formed from a pigment (e.g., ink, paint and the like) and can include a wood-grain design, a brushed metal design, a graphic design, a portrait, or a logo. The pigment design may be printed onto the glass substrate. In one or more embodiments, the anti-glare surface includes an etched surface. In one or more embodiments, the anti-reflective surface includes a multi-layer coating.

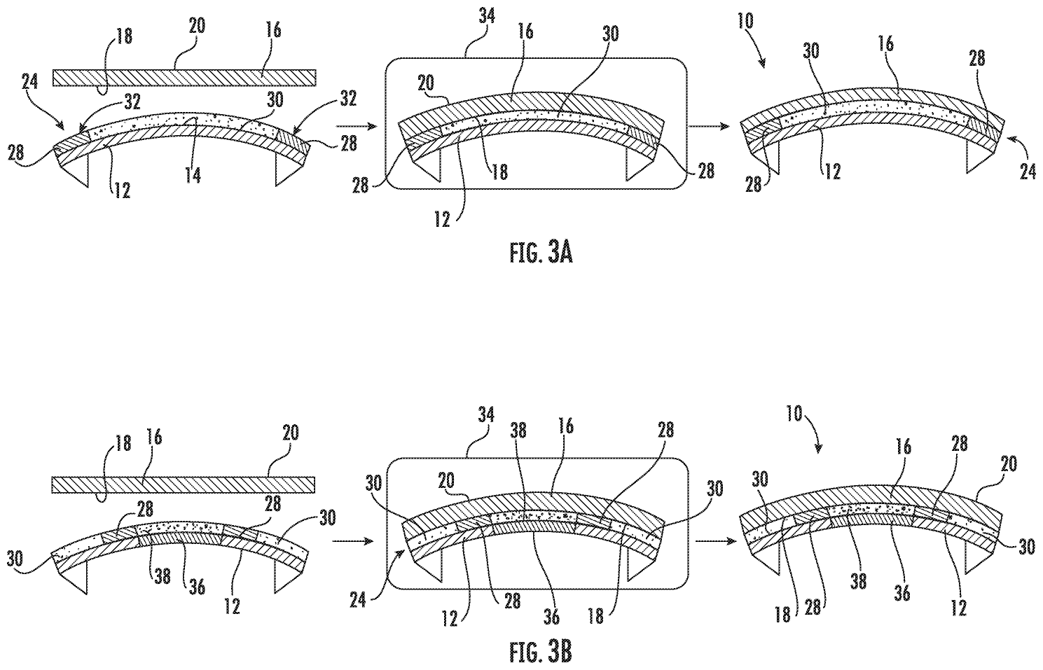

Referring to FIGS. 3A-3C, various methods of cold forming a glass article 10, such as display 130, and an associated curved frame 12 is shown. As used herein, the terms “cold-bent,” “cold bending,” “cold-formed” or “cold forming” refers to curving the glass substrate at a cold-form temperature which is less than the glass transition temperature of the glass material of glass substrate 16. Advantageously, Applicant believes that these cold forming approaches allow for formation of a curved glass article 10 while preserving various coatings located on the glass substrate 16 that might otherwise be damaged or destroyed at high temperatures typically associated with conventional glass bending processes.

As shown in FIG. 3A, the glass substrate 16 is placed on top of the frame 12. As can be seen, the adhesive layer 24 includes a first adhesive 28 and a second adhesive 30. In the embodiment depicted, the first adhesive 28 is located proximal to the edge regions 32 of the frame 12. The second adhesive 30 is located between the edge regions 32 on the frame 12. As mentioned above, the first adhesive 28 is selected to provide early green strength during a cold forming process. Exemplary adhesives for the first adhesive 28 include pressure sensitive adhesives (PSA), UV curable acrylic adhesives, polyurethane (PUR) hotmelts, silicone hotmelts, etc. In embodiments, the first adhesive 28 can be cured using, e.g., one ore more of pressure, heat, or ultraviolet radiation. Further, the first adhesive 28 is selected to have a cure time of at most 10 minutes, at most 8 minutes, at most 6 minutes, at most 4 minutes, or at most 2 minutes. In embodiments, the first adhesive 28 is selected to have a cure time of between about 1 second and about 10 minutes. In a specific embodiment, the first adhesive 28 includes one or more PSA, such as 3M™ VHB™ (available from 3M, St. Paul, Minn.) and tesa® (available from tesa SE, Norderstedt, Germany), or UV curable adhesives, such as DELO DUALBOND® MF4992 (available from DELO Industrial Adhesives, Windach, Germany).

The second adhesive 30 is selected to provide long term strength after curing over the course of, e.g., about an hour at ambient temperature. In embodiments, exemplary adhesives for the second adhesive 30 include toughened epoxy, flexible epoxy, acrylics, silicones, urethanes, polyurethanes, and silane modified polymers. In specific embodiments, the second adhesive 30 includes one or more toughened epoxies, such as EP21TDCHT-LO (available from Masterbond®, Hackensack, N.J.), 3M™ Scotch-Weld™ Epoxy DP460 Off-White (available from 3M, St. Paul, Minn.). In other embodiments, the second adhesive 30 includes one or more flexible epoxies, such as Masterbond EP21TDC-2L0 (available from Masterbond®, Hackensack, N.J.), 3M™ Scotch-Weld™ Epoxy 2216 B/A Gray (available from 3M, St. Paul, Minn.), and 3M™ Scotch-Weld™ Epoxy DP125. In still other embodiments, the second adhesive 30 includes one or more acrylics, such as LORD® Adhesive 410/Accelerator 19 w/LORD® AP 134 primer, LORD® Adhesive 852/LORD® Accelerator 25 GB (both being available from LORD Corporation, Cary, N.C.), DELO PUR SJ9356 (available from DELO Industrial Adhesives, Windach, Germany), Loctite® AA4800, Loctite® HF8000. TEROSON® MS 9399, and TEROSON® MS 647-2C (these latter four being available from Henkel AG & Co. KGaA, Dusseldorf, Germany), among others. In yet other embodiments, the second adhesive 30 includes one or more urethanes, such as 3M™ Scotch-Weld™ Urethane DP640 Brown and 3M™ Scotch-Weld™ Urethane DP604, and in still further embodiments, the second adhesive 30 includes one or more silicones, such as Dow Corning® 995 (available from Dow Corning Corporation, Midland, Minn.).

In embodiments, a primer can be applied to prepare the surfaces of the glass substrate 16 and frame 12 for better adhesion to the first adhesive 28 and/or the second adhesive 30, especially for frames 12 made of metal or including metal surfaces and for the glass surface of the glass substrate 16. Further, in embodiments, an ink primer may be used in addition to or instead of the primer for metal and glass surfaces. The ink primer helps provide better adhesion between the first adhesive 28 and/or second adhesive 30 to ink covered surfaces (e.g., the pigment design mentioned above for deadfronting applications). An example of a primer is 3M™ Scotch-Weld™ Metal Primer 3901 (available from 3M, St. Paul, Minn.); other commercially available primers are also suitable for use in the present disclosure and can be selected based on surfaces involved in the bonding and on the adhesive used to create the bond.

In embodiments, the first adhesive 28 is applied to the edge regions 32 of the frame 12 to provide a barrier to contain the second adhesive 30, especially during the cold forming process. Thus, after applying the adhesive layer 24, including the first adhesive 28 and the second adhesive 30, the glass substrate 16 is positioned over the frame 12. During the cold forming process, such as vacuum forming, the glass substrate 16 is bent into conformity with the frame 12. In embodiments, the cold forming process is performed at room temperature (e.g., about 20° C.) or a slightly elevated temperature in forming chamber 34, e.g., at 200° C. or less, 150° C. or less, 100° C. or less, or at 50° C. or less. In embodiments, the glass substrate 16 is cold formed at room temperature and then the adhesive layer 24 is cured at an elevated temperature. In the particular process of vacuum molding, a vacuum provides the bending force 26 to put the glass substrate 16 into conformity with the frame 12. During cold forming in the forming chamber 34, the first adhesive 28 secures the glass substrate 16 into place on the frame 12 in a relatively short period of time (e.g., 10 minutes or less) as compared to conventional processes in which the glass substrate 16 and frame 12 are required to cure at elevated temperatures for a time period on the order of several tens of minutes.

The first adhesive 28 provides green strength to maintain the glass substrate 16 in conformity with the frame 12. The glass article 10 can then be removed from the forming chamber 34 and allowed to cure at ambient temperature until the second adhesive 30 achieves is able to provide a structural bond between the glass substrate 16 and the frame 12. Advantageously, curing the glass article 10 in this way is much more economical than previous cold forming methods because the glass article 10 does not have to be kept at elevated temperature and under vacuum throughout the forming process.

As can be seen in FIG. 3B, the first adhesive 28 and the second adhesive 30 can be arranged in different configurations in the adhesive layer 24. In FIG. 3B, the frame 12 includes a display 36, and the adhesive layer includes optically clear adhesive (OCA) 38. The OCA 38 provides adhesion between the display 36 and the glass substrate 16 without causing distortion of the images, colors, lights, etc. of the display that are transmitted through the OCA 38. In the embodiment of FIG. 3B, the first adhesive 28 provides a border around the OCA 38 to prevent contamination of the OCA 38 by the second adhesive 30. Like the previous embodiment of FIG. 3A, the first adhesive 28 of the embodiment in FIG. 3B provides early green bonding strength during cold forming. Thus, as in the previous embodiment, the glass substrate 16 is brought into conformity with the frame 12 in the forming chamber 34 and held in the bent form by the first adhesive 28. Thereafter, the glass article 10 is removed, and the second adhesive is allowed to cure to full, structural bonding strength.

FIG. 3C provides still another embodiment for the configuration of the adhesive layer 24. In the embodiment shown in FIG. 3C, the first adhesive 28 is applied at the peak of the curved surface 14 to provide a mechanism for aligning and positioning the glass substrate 16 over the frame 12. Once positioned over the frame 12, the glass substrate 16 and frame 12 are placed in the forming chamber 34 where the first adhesive 28 provides green bonding strength to keep the glass substrate 16 in conformity with the curved surface 14 of the frame 12. After cold forming, the glass article 10 is removed from the forming chamber 34 and the second adhesive 30 is allowed to cure to structural bonding strength in ambient conditions.

While each of the embodiments in FIGS. 3A-3C depict the first adhesive 28 in only a single position on the frame 12, the adhesive layer 24 can include the first adhesive 28 in multiple locations, including at the edge regions 32, at the peak of the curved surface 14, around OCA 38, and/or at other locations on the frame 12. Further, the first adhesive 28 and second adhesive 30 can be arranged to provide stress relief at various locations over the glass substrate 16 and frame 12. For example, the regions of relatively high bonding stress may develop where the second adhesive 28 is located. Such high bonding stress regions may be stress relieved in the surrounding regions by locating the first adhesive 28, which will have a relatively lower bonding stress, in surrounding regions.

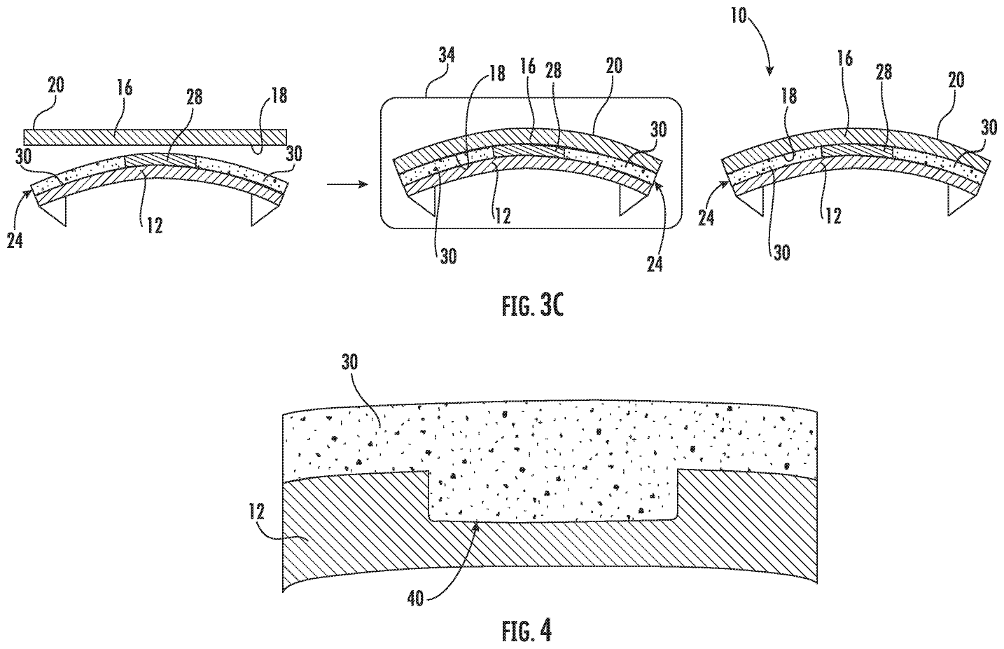

FIG. 4 provides a close-up view of the second adhesive 30 bonded to the frame 12. In the depicted embodiment, the frame 12 includes slots 40 into which the second adhesive 30 is able to flow to create a mechanical interlock with the frame 12. The mechanical interlock provides another mechanism to join the glass substrate 16 to the frame 12 and allows a place for excess second adhesive 30 to flow into during cold forming.

In various embodiments, glass substrate 16 is formed from a strengthened glass sheet (e.g., a thermally strengthened glass material, a chemically strengthened glass sheet, etc.) In such embodiments, when glass substrate 16 is formed from a strengthened glass material, first major surface 18 and second major surface 20 are under compressive stress, and thus second major surface 20 can experience greater tensile stress during bending to the convex shape without risking fracture. This allows for strengthened glass substrate 16 to conform to more tightly curved surfaces.

A feature of a cold-formed glass substrate is an asymmetric surface compressive between the first major surface 18 and the second major surface 20 once the glass substrate has been bent to the curved shape. In such embodiments, prior to the cold-forming process or being cold-formed, the respective compressive stresses in the first major surface 18 and the second major surface 20 of glass substrate 16 are substantially equal. After cold-forming, the compressive stress on concave first major surface 18 increases such that the compressive stress on the first major surface 18 is greater after cold-forming than before cold-forming. In contrast, convex second major surface 20 experiences tensile stresses during bending causing a net decrease in surface compressive stress on the second major surface 20, such that the compressive stress in the second major surface 20 following bending is less than the compressive stress in the second major surface 20 when the glass sheet is flat.

As noted above, in addition to providing processing advantages such as eliminating expensive and/or slow heating steps, the cold-forming processes discussed herein are believed to generate curved glass articles with a variety of properties that are superior to hot-formed glass articles, particularly for vehicle interior or display cover glass applications. For example, Applicant believes that, for at least some glass materials, heating during hot-forming processes decreases optical properties of curved glass sheets, and thus, the curved glass substrates formed utilizing the cold-bending processes/systems discussed herein provide for both curved glass shapes along with improved optical qualities not believed achievable with hot-bending processes.

Further, many glass surface treatments (e.g., anti-glare coatings, anti-reflective coatings, easy-to-clean coating, etc.) are applied via deposition processes, such as sputtering processes that are typically ill-suited for coating curved glass articles. In addition, many surface treatments (e.g., anti-glare coatings, anti-reflective coatings, easy-to-clean coating, etc.) also are not able to survive the high temperatures associated with hot-bending processes. Thus, in particular embodiments discussed herein, one or more surface treatments are applied to the first major surface 18 and/or to the second major surface 20 of glass substrate 16 prior to cold-bending, and the glass substrate 16 including the surface treatment is bent to a curved shape as discussed herein. Thus, Applicant believes that the processes and systems discussed herein allow for bending of glass after one or more coating materials have been applied to the glass, in contrast to typical hot-forming processes.

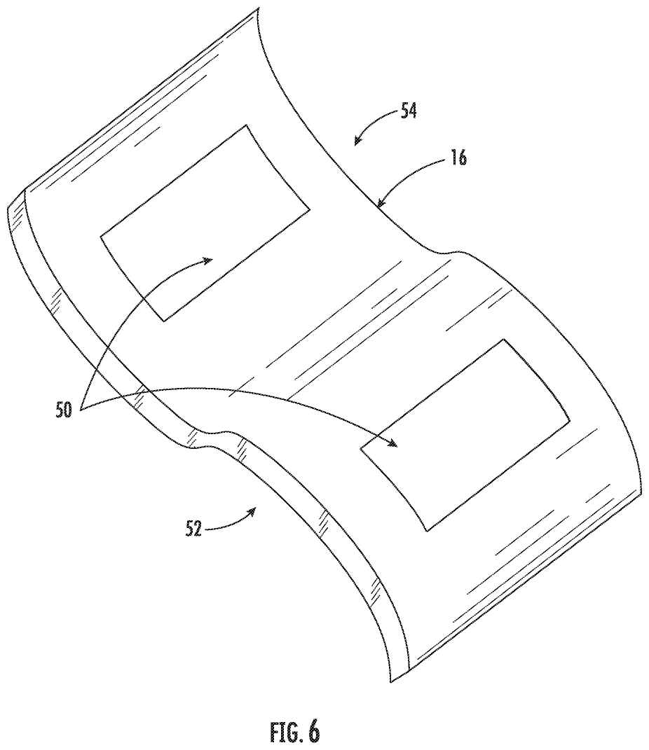

It should be noted that, in FIGS. 2 and 3A-C, the glass substrate 16 is shown having a single curvature such that second major surface 20 has a single convex radius of curvature and the first major surface 18 has a single concave radius of curvature. However, the method discussed herein allows for the glass substrate 16 to be bent to more complex shapes. For example, as shown in FIG. 6, the glass substrate 16 is bent to a shape such that the first major surface 18 has both convex and concave curved sections, and the second major surface 20 has both convex and concaved curved sections, forming an S-shaped glass substrate when viewed in cross-section. Additionally, the glass substrate 16 may include flat regions (not shown) between curved sections.

In various embodiments, a cold-formed glass substrate 16 may have a compound curve including a major radius and a cross curvature. A complexly curved cold-formed glass substrate 16 may have a distinct radius of curvature in two independent directions. According to one or more embodiments, a complexly curved cold-formed glass substrate 16 may thus be characterized as having “cross curvature,” where the cold-formed glass substrate 16 is curved along an axis (i.e., a first axis) that is parallel to a given dimension and also curved along an axis (i.e., a second axis) that is perpendicular to the same dimension. The curvature of the cold-formed glass substrate and the curved display can be even more complex when a significant minimum radius is combined with a significant cross curvature, and/or depth of bend. In various embodiments, glass substrate 16 can have more than two curved regions with the same or differing curved shapes. In some embodiments, glass substrate 16 can have one or more region having a curved shape with a variable radius of curvature.

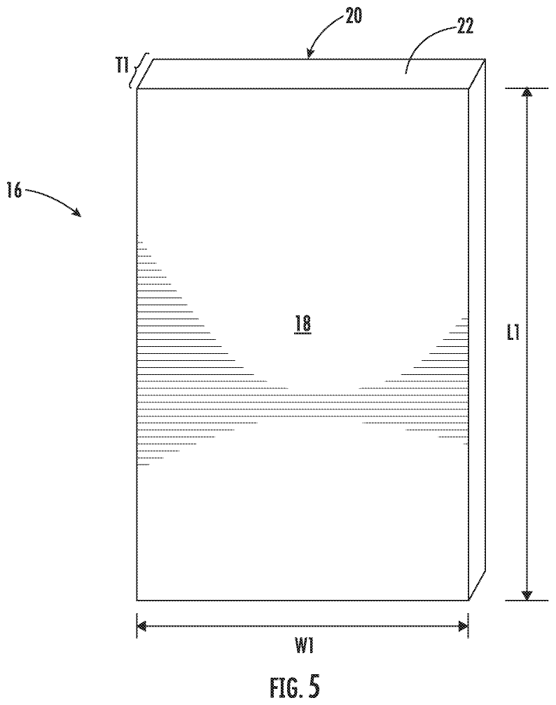

Referring to FIG. 5, additional structural details of glass substrate 16 are shown and described. As noted above, glass substrate 16 has a thickness T1 that is substantially constant and is defined as a distance between the first major surface 18 and the second major surface 20. In various embodiments, T1 may refer to an average thickness or a maximum thickness of the glass substrate. In addition, glass substrate 16 includes a width W1 defined as a first maximum dimension of one of the first or second major surfaces 18, 20 orthogonal to the thickness T1, and a length L1 defined as a second maximum dimension of one of the first or second major surfaces 18, 20 orthogonal to both the thickness and the width. In other embodiments, W1 and L1 may be the average width and the average length of glass substrate 16, respectively.

In various embodiments, thickness T1 is 2 mm or less and specifically is 0.3 mm to 1.1 mm. For example, thickness T1 may be in a range from about 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm. In other embodiments, the T1 falls within any one of the exact numerical ranges set forth in this paragraph.

In various embodiments, width W1 is in a range from 5 cm to 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. In other embodiments, W1 falls within any one of the exact numerical ranges set forth in this paragraph.

In various embodiments, length L1 is in a range from about 5 cm to about 1500 cm, from about 50 cm to about 1500 cm, from about 100 cm to about 1500 cm, from about 150 cm to about 1500 cm, from about 200 cm to about 1500 cm, from about 250 cm to about 1500 cm, from about 300 cm to about 1500 cm, from about 350 cm to about 1500 cm, from about 400 cm to about 1500 cm, from about 450 cm to about 1500 cm, from about 500 cm to about 1500 cm, from about 550 cm to about 1500 cm, from about 600 cm to about 1500 cm, from about 650 cm to about 1500 cm, from about 650 cm to about 1500 cm, from about 700 cm to about 1500 cm, from about 750 cm to about 1500 cm, from about 800 cm to about 1500 cm, from about 850 cm to about 1500 cm, from about 900 cm to about 1500 cm, from about 950 cm to about 1500 cm, from about 1000 cm to about 1500 cm, from about 1050 cm to about 1500 cm, from about 1100 cm to about 1500 cm, from about 1150 cm to about 1500 cm, from about 1200 cm to about 1500 cm, from about 1250 cm to about 1500 cm, from about 1300 cm to about 1500 cm, from about 1350 cm to about 1500 cm, from about 1400 cm to about 1500 cm, or from about 1450 cm to about 1500 cm. In other embodiments, L1 falls within any one of the exact numerical ranges set forth in this paragraph.

In various embodiments, one or more radius of curvature (e.g., R1 shown in FIG. 2) of glass substrate 134 is about 60 mm or greater. For example, R1 may be in a range from about 60 mm to about 1500 mm, from about 70 mm to about 1500 mm, from about 80 mm to about 1500 mm, from about 90 mm to about 1500 mm, from about 100 mm to about 1500 mm, from about 120 mm to about 1500 mm, from about 140 mm to about 1500 mm, from about 150 mm to about 1500 mm, from about 160 mm to about 1500 mm, from about 180 mm to about 1500 mm, from about 200 mm to about 1500 mm, from about 220 mm to about 1500 mm, from about 240 mm to about 1500 mm, from about 250 mm to about 1500 mm, from about 260 mm to about 1500 mm, from about 270 mm to about 1500 mm, from about 280 mm to about 1500 mm, from about 290 mm to about 1500 mm, from about 300 mm to about 1500 mm, from about 350 mm to about 1500 mm, from about 400 mm to about 1500 mm, from about 450 mm to about 1500 mm, from about 500 mm to about 1500 mm, from about 550 mm to about 1500 mm, from about 600 mm to about 1500 mm, from about 650 mm to about 1500 mm, from about 700 mm to about 1500 mm, from about 750 mm to about 1500 mm, from about 800 mm to about 1500 mm, from about 900 mm to about 1500 mm, from about 950 mm to about 1500 mm, from about 1000 mm to about 1500 mm, from about 1250 mm to about 1500 mm, from about 60 mm to about 1400 mm, from about 60 mm to about 1300 mm, from about 60 mm to about 1200 mm, from about 60 mm to about 1100 mm, from about 60 mm to about 1000 mm, from about 60 mm to about 950 mm, from about 60 mm to about 900 mm, from about 60 mm to about 850 mm, from about 60 mm to about 800 mm, from about 60 mm to about 750 mm, from about 60 mm to about 700 mm, from about 60 mm to about 650 mm, from about 60 mm to about 600 mm, from about 60 mm to about 550 mm, from about 60 mm to about 500 mm, from about 60 mm to about 450 mm, from about 60 mm to about 400 mm, from about 60 mm to about 350 mm, from about 60 mm to about 300 mm, or from about 60 mm to about 250 mm. In other embodiments, R1 falls within any one of the exact numerical ranges set forth in this paragraph.

As shown in FIG. 6, glass substrate 16 can include one or more regions 50 intended to show a display (e.g., an electronic display). In addition, a glass substrate according to some embodiments can be curved in multiple regions 52 and 54 of the glass substrate and in multiple directions (i.e., the glass substrate can be curved about different axes that may or may not be parallel) as shown in FIG. 6. Accordingly, shapes and forms of the possible embodiments are not limited to the examples shown herein. Glass substrate 16 can be shaped to have a complex surface including multiple different shapes including one or more flat sections, one or more conical sections, one or more cylindrical sections, one or more spherical sections, etc.

The various embodiments of the vehicle interior system may be incorporated into vehicles such as trains, automobiles (e.g., cars, trucks, buses and the like), sea craft (boats, ships, submarines, and the like), and aircraft (e.g., drones, airplanes, jets, helicopters and the like).

### Strengthened Glass Properties

As noted above, glass substrate 16 may be strengthened. In one or more embodiments, glass substrate 16 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass substrate 16 may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching.

In various embodiments, glass substrate 16 may be chemically strengthened by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as A_{g}⁺ or the like. In such embodiments, the monovalent ions (or cations) exchanged into the glass substrate generate a stress.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ions (e.g., Na+and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the article and any crystalline phases present) and the desired DOC and CS of the glass substrate that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

In one or more embodiments, the glass substrates may be immersed in a molten salt bath of 100% NaNO₃, 100% KNO₃, or a combination of NaNO₃ and KNO₃ having a temperature from about 370° C. to about 480° C. In some embodiments, the glass substrate may be immersed in a molten mixed salt bath including from about 5% to about 90% KNO₃ and from about 10% to about 95% NaNO₃. In one or more embodiments, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass substrate. The spike may result in a greater surface CS value. This spike can be achieved by a single bath or multiple baths, with the bath(s) having a single composition or mixed composition, due to the unique properties of the glass compositions used in the glass substrates described herein.

In one or more embodiments, where more than one monovalent ion is exchanged into the glass substrate, the different monovalent ions may exchange to different depths within the glass substrate (and generate different magnitudes stresses within the glass substrate at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass substrate is chemically strengthened by an ion exchange treatment, FSM or SCALP may be used depending on which ion is exchanged into the glass substrate. Where the stress in the glass substrate is generated by exchanging potassium ions into the glass substrate, FSM is used to measure DOC. Where the stress is generated by exchanging sodium ions into the glass substrate, SCALP is used to measure DOC. Where the stress in the glass substrate is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by FSM. Central tension or CT is the maximum tensile stress and is measured by SCALP.

In one or more embodiments, the glass substrate may be strengthened to exhibit a DOC that is described as a fraction of the thickness T1 of the glass substrate (as described herein). For example, in one or more embodiments, the DOC may be equal to or greater than about 0.05T1, equal to or greater than about 0.1T1, equal to or greater than about 0.11T1, equal to or greater than about 0.12T1, equal to or greater than about 0.13T1, equal to or greater than about 0.14T1, equal to or greater than about 0.15T1, equal to or greater than about 0.16T1, equal to or greater than about 0.17T1, equal to or greater than about 0.18T1, equal to or greater than about 0.19T1, equal to or greater than about 0.2T1, equal to or greater than about 0.21T1. In some embodiments, the DOC may be in a range from about 0.08T1 to about 0.25T1, from about 0.09T1 to about 0.25T1, from about 0.18T1 to about 0.25T1, from about 0.11T1 to about 0.25T1, from about 0.12T1 to about 0.25T1, from about 0.13T1 to about 0.25T1, from about 0.14T1 to about 0.25T1, from about 0.15T1 to about 0.25T1, from about 0.08T1 to about 0.24T1, from about 0.08T1 to about 0.23T1, from about 0.08T1 to about 0.22T1, from about 0.08T1 to about 0.21T1, from about 0.08T1 to about 0.2T1, from about 0.08T1 to about 0.19T1, from about 0.08T1 to about 0.18T1, from about 0.08T1 to about 0.17T1, from about 0.08T1 to about 0.16T1, or from about 0.08T1 to about 0.15T1. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm. In other embodiments, DOC falls within any one of the exact numerical ranges set forth in this paragraph.

In one or more embodiments, the strengthened glass substrate may have a CS (which may be found at the surface or a depth within the glass substrate) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the strengthened glass substrate may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa. In other embodiments, CS falls within the exact numerical ranges set forth in this paragraph.

### Glass Compositions

Suitable glass compositions for use in glass substrate 16 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO2 in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition includes A1203 in an amount greater than about 4 mol %, or greater than about 5 mol %. In one or more embodiments, the glass composition includes A1203 in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass. In this regard, the glass composition or article formed therefrom includes Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P2O5 (e.g., about 0.01 mol % or greater). In one or more embodiments, the glass composition comprises a non-zero amount of P₂O₅ up to and including 2 mol %, 1.5 mol %, 1 mol %, or 0.5 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition includes a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition includes Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition includes less than about 4 mol % K₂O, less than about 3 mol % K₂O, or less than about 1 mol % K₂O. In some instances, the glass composition may include K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In some embodiments, the glass composition includes a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition includes CaO in an amount less than about 1 mol %, less than about 0.8 mol %, or less than about 0.5 mol %. In one or more embodiments, the glass composition is substantially free of CaO.

In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO2 in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO2 in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to (and including) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition includes TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass substrate 134 may be made from any glass composition falling with any one of the exact numerical ranges discussed above.

Aspect (1) pertains to a method of forming a curved glass article, comprising the steps of: applying a first adhesive to a first region of a frame or of a glass cover sheet, the frame comprising a curved surface; applying a second adhesive to a second region of the frame or of the glass cover sheet; molding the glass cover sheet to the frame so as to conform the glass cover sheet to the curved surface of the frame; curing the first adhesive at a first temperature for a first time period; and curing the second adhesive at a second temperature for a second period of time; wherein the second temperature is lower than the first temperature; and wherein the second period of time is longer than the first period of time.

Aspect (2) pertains to the method of Aspect (1), wherein the first adhesive comprises a pressure sensitive adhesive, and wherein the method further comprises applying pressure to the pressure sensitive adhesive to cause the pressure sensitive adhesive to cure.

Aspect (3) pertains to the method of Aspect (1), wherein the first adhesive comprises a UV curable acrylic adhesive, and wherein the method further comprises applying UV light to the UV curable acrylic adhesive to cause the UV curable acrylic adhesive to cure.

Aspect (4) pertains to the method of Aspect (2) or Aspect (3), wherein the first temperature is room temperature.

Aspect (5) pertains to the method of Aspect (1), wherein the first adhesive comprises at least one of a pressure sensitive adhesive, a UV curable acrylic adhesive, a polyurethane hotmelt, or a silicone hotmelt.

Aspect (6) pertains to the method of any one of Aspects (1) through (5), wherein the second adhesive comprises at least one of a toughened adhesive, a flexible epoxy, an acrylic, a urethane, or a silicone.

Aspect (7) pertains to the method of any one of Aspects (1) through (6), wherein the first time period is no more than 10 minutes.

Aspect (8) pertains to the method of any one of Aspects (1) through (7), wherein the first temperature is no more than about 220° C.

Aspect (9) pertains to the method of any one of Aspects (1) through (8), wherein the second temperature is no more than 60° C.

Aspect (10) pertains to the method of any one of Aspects (1) through (9), wherein the second time period is at least 30 min.

Aspect (11) pertains to the method of any one of Aspects (1) through (10), wherein the step of molding comprises vacuum molding the glass cover sheet to the frame.

Aspect (12) pertains to the method of any one of Aspects (1) through (11), further comprising the step of forming at least one slot in the frame, and wherein during the step of curing the second adhesive, the method further comprises forming a mechanical interlock between the second adhesive and the at least one slot of the frame.

Aspect (13) pertains to the method of any one of Aspects (1) through (12), further comprising the step of bonding a display to the frame using optically clear adhesive, wherein the step of applying the first adhesive to the first region of the frame comprises applying the first adhesive around the optically clear adhesive such that the second adhesive does not contact the optically clear adhesive.

Aspect (14) pertains to the method of any one of Aspects (1) through (13), wherein the first region encloses lateral edges of the second region so that the first adhesive prevents leakage of the second adhesive from between the glass cover sheet and the frame.

Aspect (15) pertains to the method of any one of Aspects (1) through (14), wherein the glass cover sheet comprises a chemically strengthened aluminosilicate glass composition.

Aspect (16) pertains to the method of any one of Aspects (1) through (15), wherein the glass cover sheet has a thickness of from 0.4 mm to 2.0 mm.

Aspect (17) pertains to the method of any one of Aspects (1) through (16), wherein a first bonding stress between the first adhesive and the glass cover sheet in the first regions is less than a second bonding stress between the second adhesive and the glass cover sheet in the second regions.

Aspect (18) pertains to the method of any one of Aspects (1) through (17), wherein the glass cover sheet has a first major surface and a second major surface, the second major surface facing the frame, and wherein the method further comprises the step of applying a surface treatment to the first major surface.

Aspect (19) pertains to the method of Aspect (18), wherein the surface treatment is at least one of an anti-glare treatment, an anti-reflective coating, and easy-to-clean coating.

Aspect (20) pertains to a glass article, comprising: a glass cover sheet having a first major surface and a second major surface, the second major surface comprising a first curve; a frame having a third major surface and a fourth major surface, the third major surface comprising a second curve, wherein the second major surface of the cover glass sheet faces the third major surface of the frame and wherein the second curve complements the first curve; a first adhesive disposed in a first region between the first major surface of the frame and the second major surface of the glass cover sheet; and a second adhesive disposed in a second region between the first major surface of the frame and the second major surface of the glass cover sheet; wherein the first adhesive is configured to cure to a first cured strength after a first cure time at first cure temperature; wherein the second adhesive is configured to cure to a second cured strength after a second cure time longer than the first cure time at a second cure temperature lower than the first cure temperature; and wherein the second cured strength is greater than the first cured strength.

Aspect (21) pertains to the glass article of Aspect (20), wherein the first cured strength is no more than 5 MPa.

Aspect (22) pertains to the glass article of Aspect (20) or Aspect (21), wherein the second cured strength is greater than 5 MPa.

Aspect (23) pertains to the glass article of any one of Aspects (20) through (22), wherein the first adhesive comprises at least one of a pressure sensitive adhesive, a UV curable acrylic adhesive, a polyurethane hotmelt, or a silicone hotmelt.

Aspect (24) pertains to the glass article of any one of Aspects (20) through (23), wherein the second adhesive comprises at least one of a toughened adhesive, a flexible epoxy, an acrylic, a urethane, or a silicone.

Aspect (25) pertains to the glass article of any one of Aspects (20) through (24), wherein the frame comprises at least one slot formed into the third major surface, and wherein the second adhesive substantially fills the at least one slot to form a mechanical interlock with the frame.

Aspect (26) pertains to the glass article of any one of Aspects (20) through (25), further comprising a display bonded to the frame using optically clear adhesive, wherein the first adhesive encloses lateral edges of the optically clear adhesive such that the second adhesive does not contact the optically clear adhesive.

Aspect (27) pertains to the glass article of any one of Aspects (20) through (26), wherein the first regions enclose lateral edges of the second regions so that the first adhesive prevents leakage of the second adhesive from between the glass cover sheet and the frame.

Aspect (28) pertains to the glass article of any one of Aspects (20) through (27), wherein the glass cover sheet comprises a chemically strengthened aluminosilicate glass composition.

Aspect (29) pertains to the glass article of any one of Aspects (20) through (28), wherein the glass cover sheet has a thickness of from 0.4 mm to 2.0 mm.

Aspect (30) pertains to the glass article of any one of Aspects (20) through (29), further comprising a surface treatment on the first major surface of the glass cover sheet.

Aspect (31) pertains to the glass article of any one of Aspects (20) through (30), wherein the surface treatment is at least one of an anti-glare treatment, an anti-reflective coating, and easy-to-clean coating.

Aspect (32) pertains to the glass article of any one of Aspects (20) through (31), wherein the first and second curves each comprise at least one location having a radius of curvature of 100 mm or less.

Aspect (33) pertains to a vehicle interior comprising the glass article according to any of Aspect (20) through (32).

Aspect (34) pertains to a method of forming a curved glass article, comprising the steps of: applying a pressure sensitive structural adhesive to at least a portion of a frame or of a glass cover sheet, the frame comprising a curved surface; molding a glass cover sheet to the frame so as to conform the glass cover sheet to the curved surface of the frame; applying pressure to the pressure sensitive structural adhesive at a first temperature for a first time period; and curing the pressure sensitive structural adhesive at a second temperature for a second period of time; wherein the second temperature is lower than the first temperature; and wherein the second period of time is longer than the first period of time.

Aspect (35) pertains to the method of Aspect (34), wherein the glass cover sheet has a first major surface and a second major surface, the second major surface facing the frame, and wherein the method further comprises the step of applying a surface treatment to the first major surface.

Aspect (36) pertains to the method of Aspect (35), wherein the surface treatment is at least one of an anti-glare treatment, an anti-reflective coating, and easy-to-clean coating.

Aspect (37) pertains to the method of any one of Aspects (34) through (36), wherein the step of molding comprises vacuum molding the glass cover sheet to the frame.

Aspect (38) pertains to the method of any one of Aspects (34) through (37), wherein the first time period is from about 1 minute to about 10 minutes and the first temperature is no more than about 220° C.

Aspect (39) pertains to the method of any one of Aspects (34) through (38), wherein the second time period is at least 30 minutes and the second temperature is from about 20° C. to about 60° C.

Aspect (40) pertains to a glass article, comprising: a glass cover sheet having a first major surface and a second major surface, the second major surface comprising a first curve; a frame having a third major surface and a fourth major surface, the third major surface comprising a second curve, wherein the second major surface of the cover glass sheet faces the third major surface of the frame and wherein the second curve complements the first curve; a pressure sensitive structural adhesive disposed between the first major surface of the frame and the second major surface of the glass cover sheet; and wherein the pressure sensitive structural adhesive is configured to cure to a first cured strength after a first cure time at first cure temperature and to cure to a second cured strength after a second cure time longer than the first cure time at a second cure temperature lower than the first cure temperature; and wherein the second cured strength is greater than the first cured strength.

Aspect (41) pertains to the glass article of Aspect (40), wherein the first cured strength is no more than 5 MPa.

Aspect (42) pertains to the glass article of Aspect (40) or Aspect (41), wherein the second cured strength is greater than 5 MPa.

Aspect (43) pertains to the glass article of any one of Aspects (40) through (42), further comprising a display bonded to the frame using optically clear adhesive.

Aspect (44) pertains to the glass article of any one of Aspects (40) through (43), wherein the glass cover sheet comprises a chemically strengthened aluminosilicate glass composition.

Aspect (45) pertains to the glass article of any one of Aspects (40) through (44), wherein the glass cover sheet has a thickness of from 0.4 mm to 2.0 mm.

Aspect (46) pertains to the glass article of any one of Aspects (40) through (45), further comprising a surface treatment on the first major surface of the glass cover sheet.

47.The method of claim 46, wherein the surface treatment is at least one of an anti-glare treatment, an anti-reflective coating, and easy-to-clean coating.

Aspect (48) pertains to the glass article of any one of Aspects (40) through (47), wherein the first and second curves each comprise at least one location having a radius of curvature of 100 mm or less.

Aspect (49) pertains to a vehicle interior comprising the glass article according to any of Aspects (40) through (48).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A method of forming a curved glass article, comprising the steps of:
applying a first adhesive to a first region of a frame or of a glass cover sheet, the frame comprising a curved surface;
applying a second adhesive to a second region of the frame or of the glass cover sheet;
molding the glass cover sheet to the frame so as to conform the glass cover sheet to the curved surface of the frame;
curing the first adhesive at a first temperature for a first time period; and
curing the second adhesive at a second temperature for a second period of time;
wherein the second temperature is lower than the first temperature; and
wherein the second period of time is longer than the first period of time.

2.-19. (canceled)

20. A glass article, comprising:
a glass cover sheet having a first major surface and a second major surface, the second major surface comprising a first curve;
a frame having a third major surface and a fourth major surface, the third major surface comprising a second curve, wherein the second major surface of the cover glass sheet faces the third major surface of the frame and wherein the second curve complements the first curve;
a first adhesive disposed in a first region between the first major surface of the frame and the second major surface of the glass cover sheet; and
a second adhesive disposed in a second region between the first major surface of the frame and the second major surface of the glass cover sheet;
wherein the first adhesive is configured to cure to a first cured strength after a first cure time at first cure temperature;
wherein the second adhesive is configured to cure to a second cured strength after a second cure time longer than the first cure time at a second cure temperature lower than the first cure temperature; and
wherein the second cured strength is greater than the first cured strength.

21. The glass article of claim 20, wherein the first cured strength is no more than 5 MPa, and wherein the second cured strength is greater than 5 MPa.

22. (canceled)

23. The glass article according to claim 20, wherein the first adhesive comprises at least one of a pressure sensitive adhesive, a UV curable acrylic adhesive, a polyurethane hotmelt, or a silicone hotmelt.

24. The glass article according to claim 20, wherein the second adhesive comprises at least one of a toughened adhesive, a flexible epoxy, an acrylic, a urethane, or a silicone.

25. The glass article according to claim 20, wherein the frame comprises at least one slot formed into the third major surface, and wherein the second adhesive substantially fills the at least one slot to form a mechanical interlock with the frame.

26. The glass article according to claim 20, further comprising a display bonded to the frame using optically clear adhesive, wherein the first adhesive encloses the optically clear adhesive such that the second adhesive does not contact the optically clear adhesive.

27. (canceled)

28. The glass article according to claim 20, wherein the glass cover sheet is strengthened.

29. The glass article according to claim 20, wherein the glass cover sheet has a thickness of from 0.4 mm to 2.0 mm.

30. (canceled)

31. (canceled)

32. (canceled)

33. A vehicle interior comprising the glass article according to claim 20.

34.-39. (canceled)

40. A glass article, comprising:
a glass cover sheet having a first major surface and a second major surface, the second major surface comprising a first curve;
a frame having a third major surface and a fourth major surface, the third major surface comprising a second curve, wherein the second major surface of the cover glass sheet faces the third major surface of the frame and wherein the second curve complements the first curve;
a pressure sensitive structural adhesive disposed between the first major surface of the frame and the second major surface of the glass cover sheet; and
wherein the pressure sensitive structural adhesive is configured to cure to a first cured strength after a first cure time at first cure temperature and to cure to a second cured strength after a second cure time longer than the first cure time at a second cure temperature lower than the first cure temperature; and
wherein the second cured strength is greater than the first cured strength.

41. The glass article of claim 40, wherein the first cured strength is no more than 5 MPa.

42. The glass article of claim 40, wherein the second cured strength is greater than 5 MPa.

43. The glass article according to claim 40, further comprising a display bonded to the frame using optically clear adhesive.

44. The glass article according to claim 40, wherein the glass cover sheet is strengthened.

45. The glass article according to claim 40, wherein the glass cover sheet has a thickness of from 0.4 mm to 2.0 mm.

46. The glass article according to claim 40, further comprising a surface treatment on the first major surface of the glass cover sheet.

47. The glass article of claim 46, wherein the surface treatment is at least one of an anti-glare treatment, an anti-reflective coating, and easy-to-clean coating.

48. The glass article according to claim 40, wherein the first and second curves each comprise at least one location having a radius of curvature of 100 mm or less.

49. A vehicle interior comprising the glass article according to claim 40.
